(19) United States
(12) Patent Application Publication
(10) Pub. No.: US 2024/0124078 A1
(43) Pub. Date: Apr. 18, 2024

(54) MOTORCYCLE AND ALL-TERRAIN VEHICLE TRAILER

(71) Applicant: Jason S. Mallette, Hamilton (CA)

(72) Inventor: Jason S. Mallette, Hamilton (CA)

(21) Appl. No.: 17/965,746

(22) Filed: Oct. 13, 2022

(51) Int. Cl. B62D 63/06; B60D 1/48; B62D 63/08

(52) U.S. Cl. CPC B62D 63/062; B60D 1/481; B62D 63/08

(57) ABSTRACT

A trailer for loading, unloading and transporting a vehicle is disclosed herein. Particularly, the vehicle may be a small vehicle, such as a motorcycle or an all-terrain vehicle (ATV). The trailer includes a trailer frame, a trailer base, a set of locking pins, a pair of movement pins, a pair of movement restricting pins and a trailer base moving assembly. The trailer base is movable relative to the trailer frame such that a rearward end thereof can be pivoted downward to form a ramp. Further, in some examples, the trailer base can be completely removed from the trailer frame. The trailer is preferably easy to use, scalable and makes the process of loading and unloading a vehicle safer with minimal risk of damage to the vehicle or injury to a loading person.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of trailers of existing art and more specifically relates to a trailer for use in loading and transporting small vehicles such as motorcycles and all-terrain vehicles.

### RELATED ART

There are many circumstances in which require a vehicle to tow another vehicle. For example, vehicles such as motorcycles and All-Terrain Vehicles (ATV) are often transported to particular riding areas where they can be legally ridden. To transport these vehicles, typically a trailer is used that hitches to the back of a ‘towing’ vehicle and a ramp is used to load and unload the vehicle onto a planar bed of the trailer. However, using current trailers known in the prior art, the process of unloading and loading the vehicle is a strenuous and potentially dangerous task. This is predominantly due to the steep incline of common ramps used, which can cause the vehicle to bottom out and damage the vehicle and/or cause injury to persons loading the vehicle. As such, a suitable solution is desired.

### SUMMARY OF THE INVENTION

In view of the foregoing disadvantages inherent in the known trailer art, the present disclosure provides a novel motorcycle and all-terrain vehicle trailer. The general purpose of the present disclosure, which will be described subsequently in greater detail, is to provide a trailer that is used in particular to load and transport motorcycles and all-terrain vehicles and that includes a movable base (or bed) that improves the process of loading and unloading the motorcycles and all-terrain vehicles.

A trailer for loading and transporting a vehicle is disclosed herein. The trailer may include a trailer frame, a wheel assembly, a hitch assembly, a trailer base, a set of locking pins and a trailer base moving assembly. The trailer frame may include a front rail and a pair of opposing frame rails extending rearwardly from the front rail and defining a left and right side of the trailer frame. The pair of frame rails together may include a pair of front base attachment portions and a pair of rear base attachment portions. The wheel assembly may be attached to the left and right side of the trailer frame and the hitch assembly may be located on the front rail and configured to mount the trailer to a towing vehicle.

The trailer base may define a forward end opposite a rearward end and include a pair of front frame attachment portions attached about the forward end and a pair of rear frame attachment portions attached about the rearward end. The trailer base may be configured for selective pivotal movement from the forward end thereof and sized to carry the vehicle (to be towed). Particularly, a pair of movement pins may be provided in some embodiments and configured for attachment to the pair of front frame attachment portions and the pair of front base attachment portions; the pair of movement pins may enable the pivotal movement of the forward end of the trailer base (the forward end of the base may pivot about the pair of movement pins).

The set of locking pins may include a pair of front locking pins and a pair of rear locking pins, the pair of front locking pins may be configured to lock the pair of front frame attachment portions to the pair of front base attachment portions, thereby attaching the forward end of the trailer base to the trailer frame; and the pair of rear locking pins may be configured to lock the pair of rear frame attachment portions to the pair of rear base attachment portions, thereby attaching the rearward end of the trailer base to the trailer frame. The trailer base moving assembly may be in communication with the trailer base and configured to, subsequent to removal of at least the pair of rear locking pins, selectively lower and raise at least the rearward end of the trailer base.

According to another embodiment, a method of loading a vehicle onto a trailer is also disclosed herein. The method may include: providing the trailer as above; mounting the trailer to a towing vehicle using the hitch assembly; removing the pair of rear locking pins from the pair of rear frame attachment portions and the pair of rear base attachment portions, thereby detaching the rearward end of the trailer base from the trailer frame; removing the pair of movement restricting pins from the pair of front frame attachment portions and the pair of front base attachment portions, thereby permitting the forward end of the trailer base to pivot about the pair of movement pins and enabling the rearward end of the trailer base to move downward, forming a ramp; driving the vehicle onto the trailer base; securing the vehicle to the trailer base; utilizing the trailer base moving assembly to raise the rearward end of the trailer base; attaching the pair of rear locking pins to the pair of rear frame attachment portions and the pair of rear base attachment portions, thereby attaching the rearward end of the trailer base to the trailer frame; and attaching the pair of movement restricting pins to the pair of front frame attachment portions and the pair of front base attachment portions, thereby arresting pivotal movement of the trailer base from the forward end thereof.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a motorcycle and all-terrain vehicle trailer, constructed and operative according to the teachings of the present disclosure.

FIG. 1 is a perspective view of a motorcycle loaded and secured onto a trailer with a front wheel of the motorcycle being locked into a wheel lock on the trailer, the trailer including a trailer frame and a trailer base, according to an embodiment of the disclosure.

FIG. 2 is a side view of the trailer, according to an embodiment of the present disclosure.

FIG. 3 is a top view of the trailer of FIG. 2 with the trailer base removed from the trailer frame, according to an embodiment of the present disclosure.

FIG. 4 is a top view of the trailer of FIG. 3 with the trailer base attached to the trailer frame, according to an embodiment of the present disclosure.

FIG. 5 is a front view of the trailer of FIG. 2, according to an embodiment of the present disclosure.

FIG. 6A is a side view of a pair of panels of the wheel lock, according to an embodiment of the present disclosure.

FIG. 6B is a top view of the pair of panels attached together and including a spring lock assembly, according to an embodiment of the present disclosure.

FIG. 6C is a front view of the spring lock assembly including a spring and rod combination and a pair of wingnuts, according to an embodiment of the present disclosure.

FIG. 7 is a perspective view of the trailer of FIG. 1 and illustrating a rearward end of the trailer base being pivoted downward to form a ramp, according to an embodiment of the disclosure.

FIG. 8A is a top view of a front base attachment portion, according to an embodiment of the disclosure.

FIG. 8B is a side view of the front base attachment portion, according to an embodiment of the disclosure.

FIG. 8C is a front view of the front base attachment portion, according to an embodiment of the disclosure.

FIG. 9A is a top view of a rear base attachment portion, according to an embodiment of the disclosure.

FIG. 9B is a side view of the rear base attachment portion, according to an embodiment of the disclosure.

FIG. 9C is a front view of the rear base attachment portion, according to an embodiment of the disclosure.

FIG. 10A is a top view of a front frame attachment portion, according to an embodiment of the disclosure.

FIG. 10B is a bottom view of the front frame attachment portion, according to an embodiment of the disclosure.

FIG. 10C is a side view of the front frame attachment portion, according to an embodiment of the disclosure.

FIG. 10D is a front view of the front frame attachment portion, according to an embodiment of the disclosure.

FIG. 11 is a side view of the front base attachment portion attached to the front frame attachment portion, according to an embodiment of the disclosure.

FIG. 12 is a side view of the rear base attachment portion attached to a rear frame attachment portion, according to an embodiment of the disclosure.

FIG. 13 is a front view of the rear base attachment portion attached to the rear frame attachment portion, according to an embodiment of the disclosure.

FIG. 14 is a magnified view of a portion of FIG. 3 denoted by a circle labeled 10 in FIG. 3 and illustrating a pulley system and a cable system, according to an embodiment of the disclosure. The wheel lock has been omitted for clarity,

FIG. 15 is a magnified view of a portion of FIG. 14 denoted by a circle labeled 11 in FIG. 14 and illustrating the front base attachment portion attached to the frame attachment portion via a locking pin, a movement restricting pin and a bolt, according to an embodiment of the disclosure.

FIG. 16 is a front view of the trailer frame and illustrating the movement restricting pin being inserted into the front base attachment portion, according to an embodiment of the disclosure.

FIG. 17 is a flow diagram illustrating a method of loading a vehicle onto a trailer, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a trailer and more particularly to a motorcycle and all-terrain vehicle trailer. Generally, the trailer may be composed of two parts: a base and a frame. The base may carry a motorcycle, an all-terrain vehicle (ATV) or any other vehicle up to a particular weight, length and width (dependent on size of the base). The frame may include an axle-less wheel and a simple spring suspension system, a hand winch, a hitch, and a hook-up system to removably attach the base to the frame. The trailer may be mainly composed of aluminum; however, it should be appreciated that the trailer is not limited to being composed of aluminum and may be interchanged with materials having a comparable strength. The trailer may be easy to use, scalable and makes the process of loading and unloading a vehicle safer.

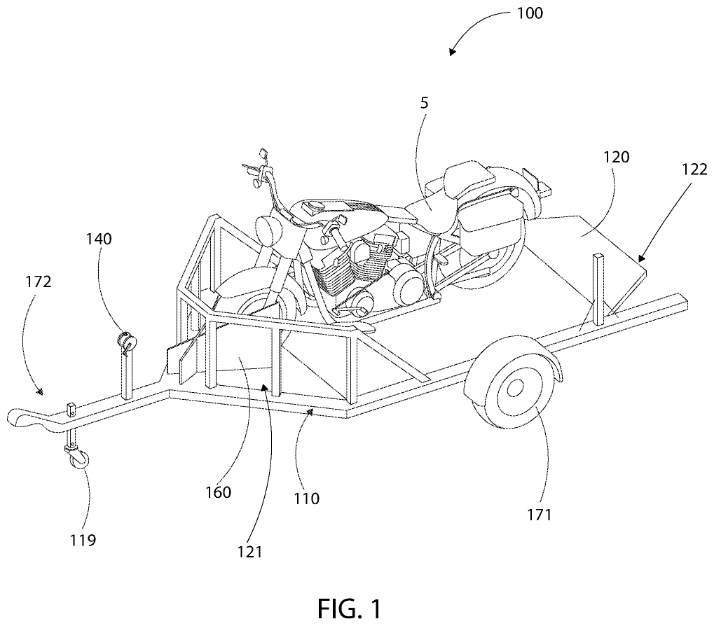

Referring now more specifically to the drawings by numerals of reference, there is shown in FIGS. 1-16, various views of a trailer 100 for loading and transporting a vehicle 5. The trailer 100 may include, in particular, a trailer frame 110, a trailer base 120, a wheel assembly 171, a hitch assembly 172, a trailer base 120, and a set of locking pins 130. It should be noted that, in this specification and the drawings, elements that have substantially the same function and structure are denoted with the same reference signs, and repeated explanation and illustration is omitted.

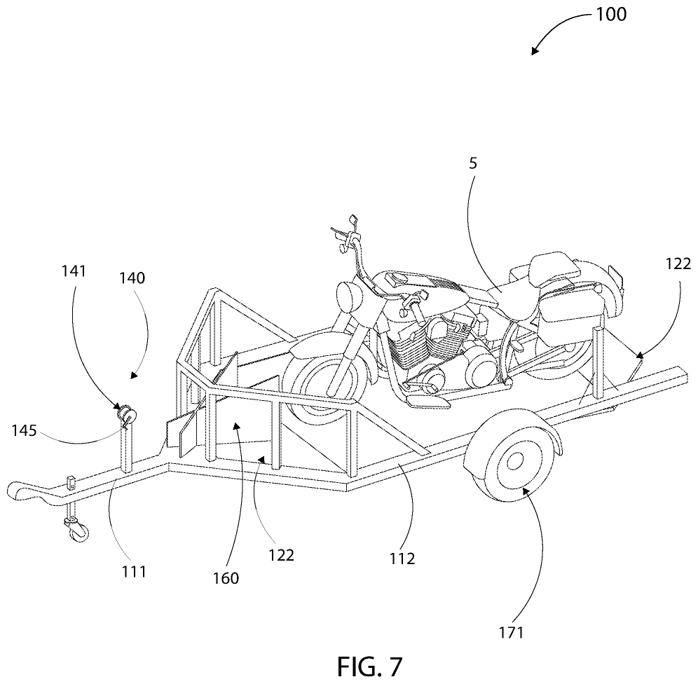

The trailer 100 may attach to a towing vehicle and may be particularly used for loading and transporting a vehicle 5 onto the trailer base 120. For example, as shown in FIG. 1 (and FIG. 7) the vehicle 5 may be a motorcycle. In other examples, the vehicle 5 may be an all-terrain vehicle (ATV). It should also be appreciated that whilst motorcycles and ATVs are provided are discussed as the vehicle 5 in the present disclosure, the vehicle 5 is not limited to being a motorcycle or ATV. For example, golf carts, mobility scooters, etc. may be loaded and transported by the trailer 100.

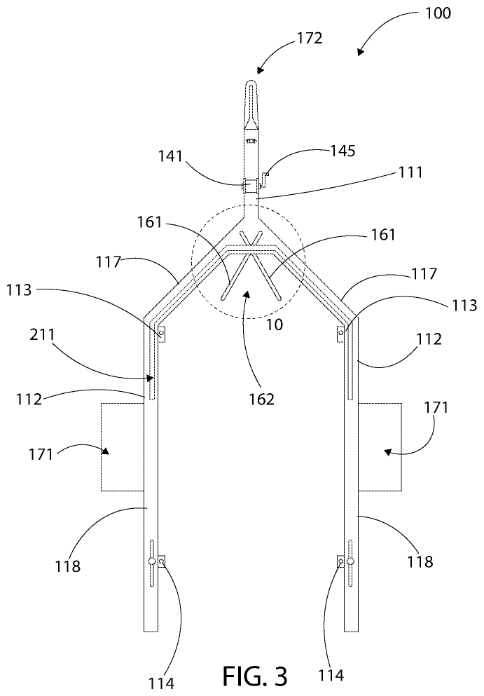

As shown in FIGS. 1-4, the trailer frame 110 may include a front rail 111 and a pair of opposing, substantially parallel frame rails 112 extending rearwardly from the front rail 111 and defining a left and right side of the trailer frame 110. In some embodiments, as shown particularly in FIG. 3, the pair of opposing frame rails 112 may each include an angled section 117 and a linear section 118. The angled section 117 may be attached to the front rail 111 and extending at a 45 degree angle therefrom and the linear section 118 may extend substantially parallel to the front rail 111 (with both linear sections 118 from the pair of opposing frame rails 112 also being parallel and spaced opposite each other).

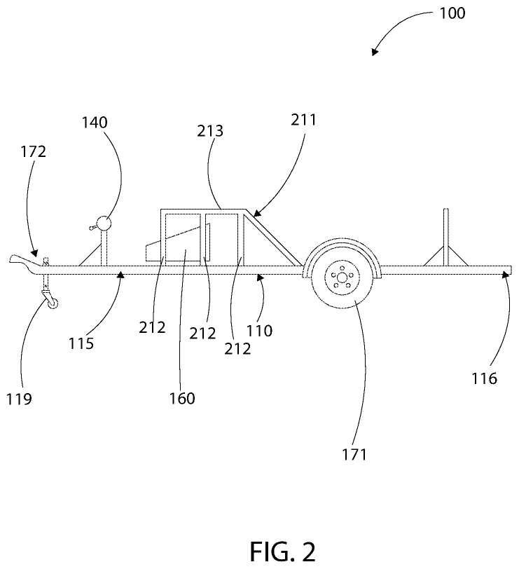

Further, in some embodiments, the trailer frame 110 may also include an upper frame 211 (FIGS. 2-5), attached to and extending above the pair of opposing frame rails 112. Particularly, the upper frame 211 may include one or more vertical posts 212 extending upwardly from the pair of opposing frame rails 112 and an upper pair of opposing frame rails 213 extending rearwardly from the one or more vertical posts 212. The upper frame 211 may include a similar shape to the (lower) pair of opposing frame rails 112.

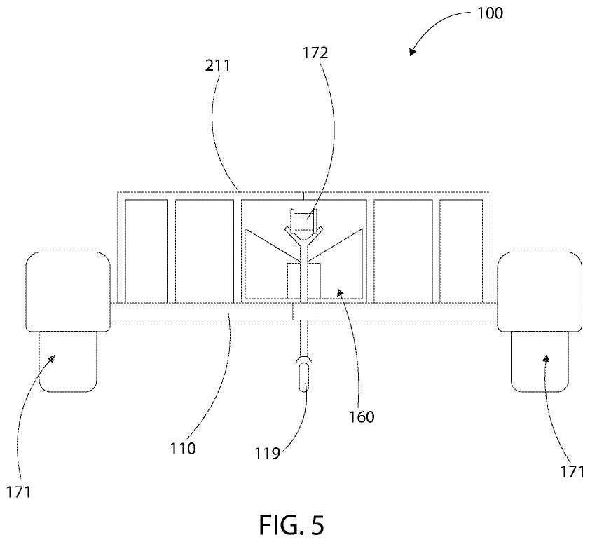

The wheel assembly 171 may be attached to the trailer frame 110. In particular, as shown in FIG. 5, the wheel assembly 171 may include a pair of axel-less wheels attached at opposite sides of the trailer frame 110. The wheel assembly 171 may contact a ground surface and aid in movement of the trailer 100. Further, the hitch assembly 172 (FIGS. 1-4) may be located on the front rail 111. The hitch assembly 172 may include a standard 1¾-2 inch ball receiver. In some embodiments, the front rail 111 may be slid into the hitch assembly 172. Further, as shown in FIGS. 1-2 and FIG. 5, a support wheel 119 may be provided on the trailer frame 110 and located underneath the hitch assembly 172.

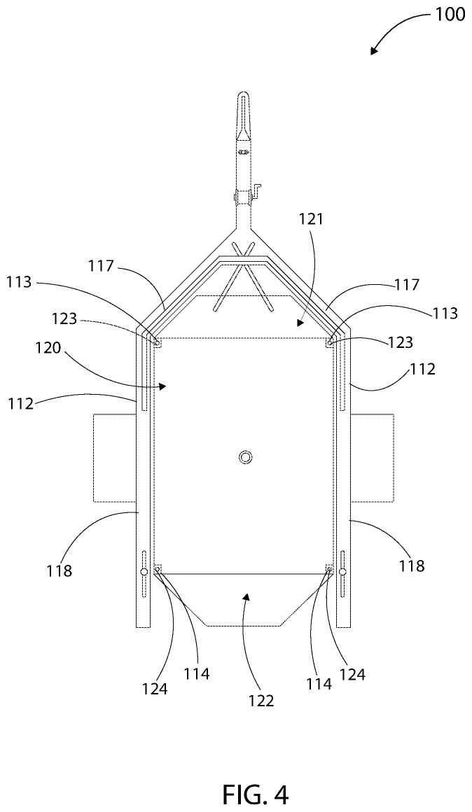

As shown in FIGS. 3-4, the pair of opposing frame rails 112 may together include a pair of front base attachment portions 113 (located at a front end 115 of the trailer frame 110) and a pair of rear base attachment portions 114 (located at a rear end 116 of the trailer frame 110). Further, the trailer base 120 may define a forward end 121 (relative to the front end 115 of the trailer frame 110) and a rearward end 122 (relative to the rear end 116 of the trailer frame 110). As shown in FIG. 4, the trailer base 120 may include four frame attachment portions 123, 124 located at the forward end 121 and the rearward end 122 of the trailer base 120. The trailer base 120 may include (but is not limited to) expanded metal grating at the rearward and forward end 121, 122 thereof and an aluminum tread plate therebetween. Further, as shown in FIG. 4, the rearward and forward end 121, 122 may include tapered edges.

As above and as shown in FIG. 1 and FIG. 7, the vehicle 5 may be (but is not limited to being) a motorcycle. In this embodiment, the trailer may further comprise a wheel lock 160 attached toward the front end 115 of the trailer frame 110 (directly in front of the trailer base 120 when attached to the trailer frame 110). As shown in FIG. 1, the wheel lock 160 may be configured to receive and stabilize a wheel of the vehicle 5 (when the vehicle 5 is loaded onto the trailer base 120). For example, the wheel lock 160 may be configured to receive and stabilize a front wheel of the motorcycle, to center the motorcycle in the trailer 100 and support it during transportation.

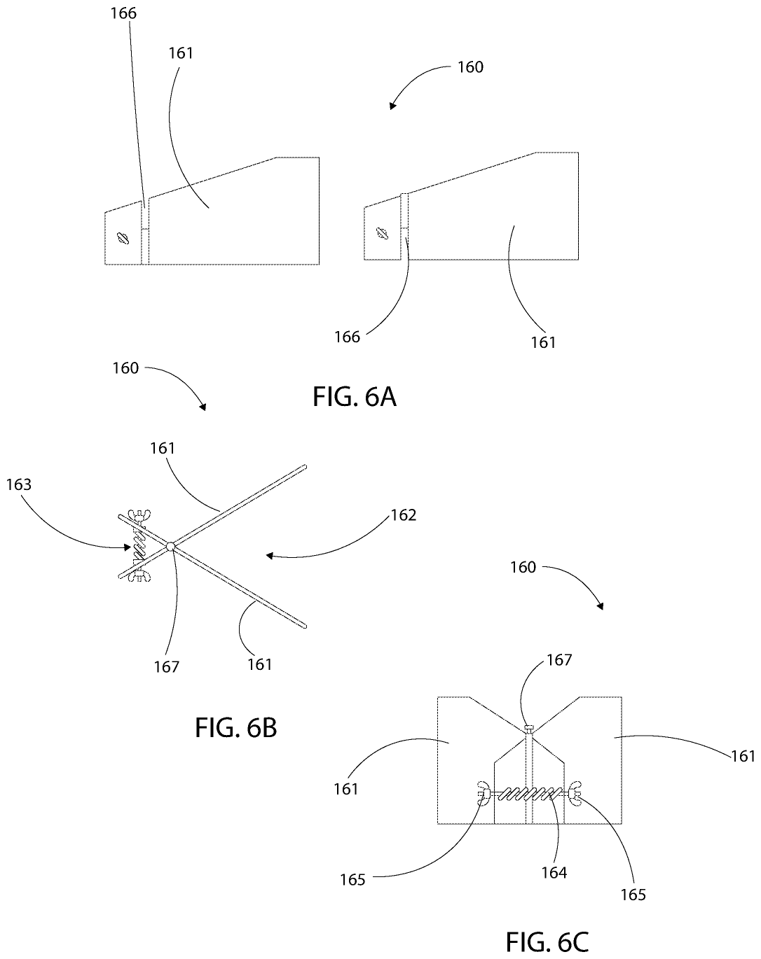

As shown in FIGS. 6A-6C, the wheel lock 160 may include a pair of panels 161. The pair of panels 161 may be attached together at a front thereof (relative to the front end 115 of the trailer frame 110) and may define an opening 162 configured to receive the wheel of the vehicle 5. The pair of panels 161 may be movable relative to each other to increase and decrease a size of the opening 162, enabling differently sized wheels to be placed into the wheel lock 160. Particularly, the pair of panels 161 may be movable via a hinge 167. For example, the hinge 167 may include a center pin around which the pair of panels 161 pivot to increase and decrease the size of the opening 162.

As shown in FIGS. 6B-6C, the wheel lock 160 may further include a spring lock assembly 163 also located at the front of the pair of panels 161 and configured to lock the opening 162 around the wheel of the vehicle 5 (as shown in FIG. 1). Particularly, the spring lock assembly 163 may include a spring and rod combination 164 and a pair of wingnuts 165 located on opposing ends of the spring and rod combination 164. To install, the pair of panels 161 may be attached together via a slot 166 (FIG. 6A) located at the front of both panels 161. The hinge 167, or center pin, may then be inserted therein to enable pivoting of the pair of panels 161. The spring and rod combination 164 may then be thread through apertures located in the front of both of the pair of panels 161 and wingnuts 165 may be threaded onto each end of the spring and rod combination 164 and abutted against an exterior of the pair of panels 161. To lock the opening 162 in a certain position around the wheel, the wingnuts 165 may be tightened against the exterior of the pair of panels 161.

Referring more specifically to FIGS. 7-16 there is shown elements of the trailer 100 which provide for improved loading and unloading of the vehicle 5. As above, the trailer frame 110 may include four base attachment portions 113, 114 and the trailer base 120 may include four frame attachment portions 123, 124. Particularly, the four frame attachment portions 123, 124 may include a pair of front frame attachment portions 123 attached about the forward end 121 and configured to attach to the pair of front base attachment portions 113; and a pair of rear frame attachment portions 124 attached about the rearward end 122 and configured to attach to the pair of rear base attachment portions 114.

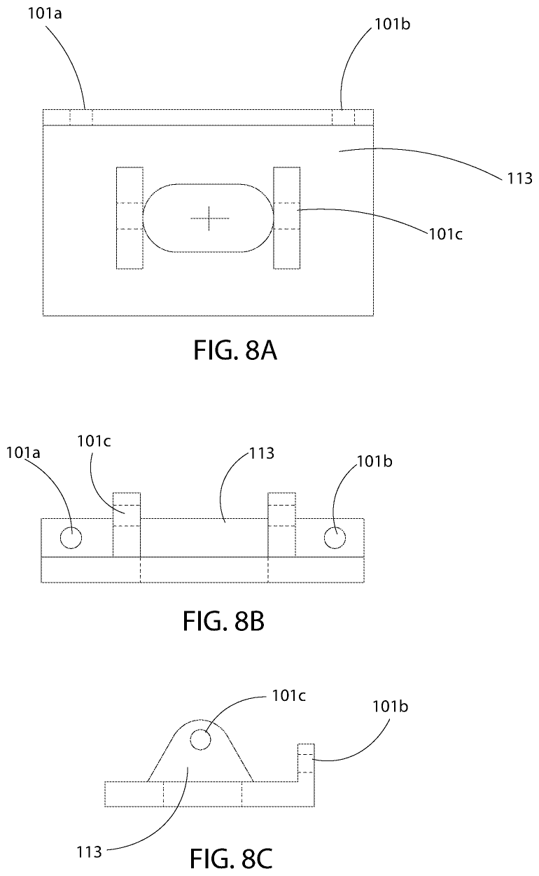

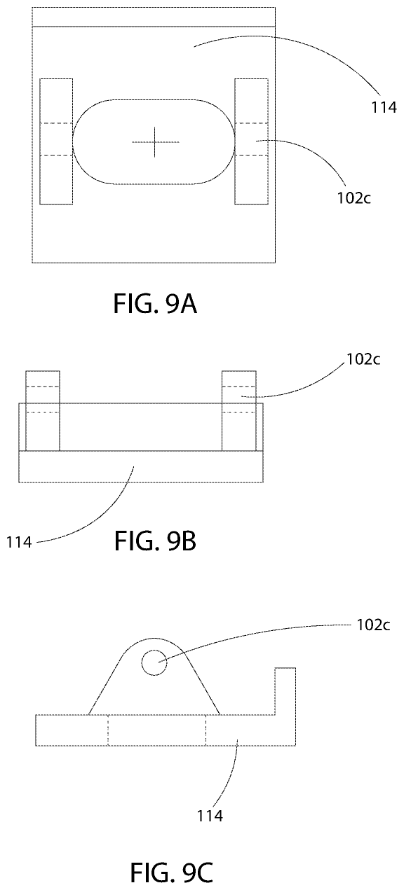

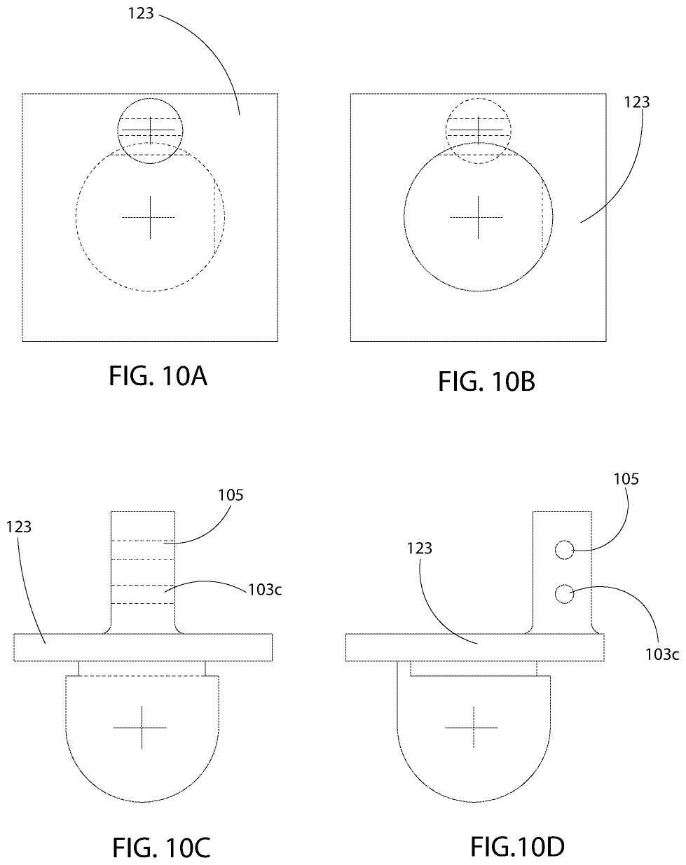

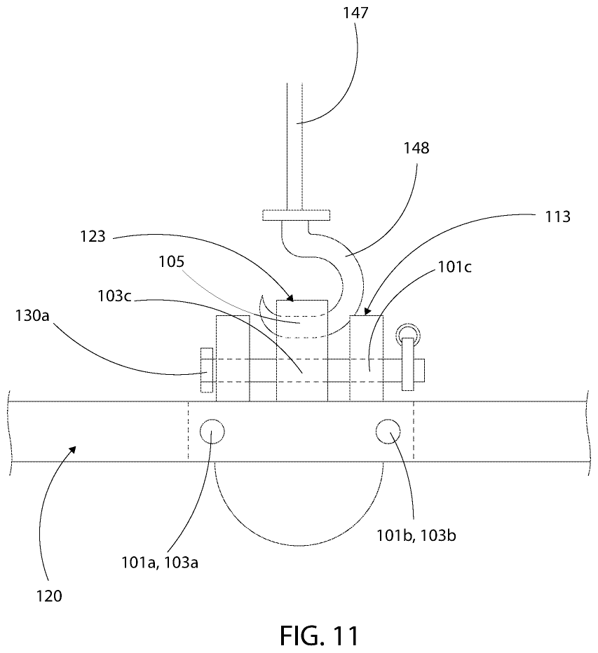

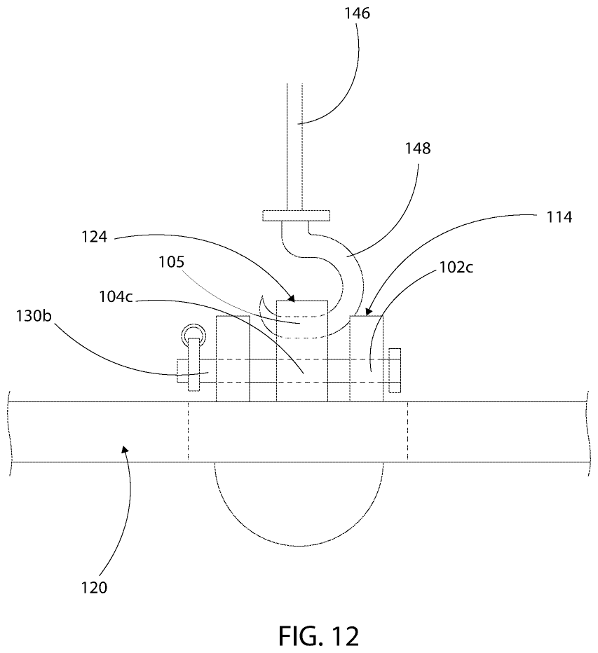

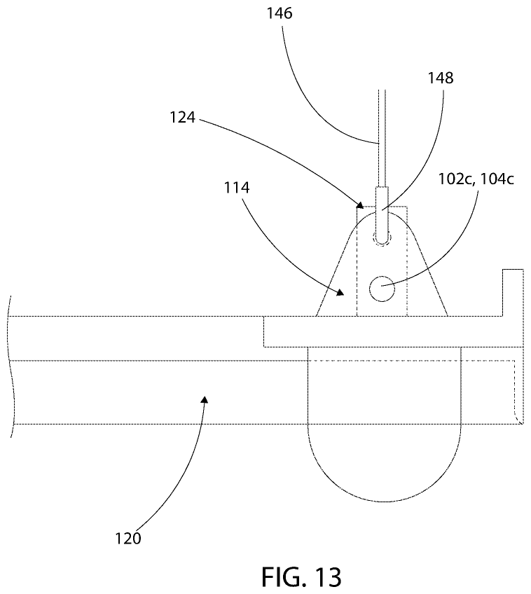

As shown in FIGS. 8A-8C and FIG. 11, in some embodiments, the pair of front base attachment portions 113 may include a bracket having three apertures 101a, 101b, 101c therein and as shown in FIGS. 10A-11, the pair of front frame attachment portions 123 may include a bracket having three (corresponding when aligned) apertures 103a, 103b, 103c therein. As shown in FIGS. 9A-9C and FIGS. 12-13, the pair of rear base attachment portions 114 may include a bracket having one aperture 102c therein and as shown in FIGS. 12-13, the pair of rear frame attachment portions 124 may include a bracket having one (corresponding when aligned) aperture 104c therein.

The set of locking pins 130 (shown in FIGS. 11-12 and FIG. 15) may include at least four locking pins 130. It is contemplated that all four of the locking pins 130 share substantially equal characteristics, however for the sake of clarity a pair of ‘front’ locking pins and a pair of ‘rear’ locking pins have been distinguished using the suffix “a” (103a) in the former and “b” (103b) in the latter. As shown in FIGS. 11-12 and FIG. 15 the pair of front locking pins 130a may each be configured to lock one of the pair of front frame attachment portions 123 to one of the pair of front base attachment portions 113, thereby attaching the forward end 121 of the trailer base 120 to the trailer frame 110. Similarly, the pair of rear locking pins 130b may be configured to lock one of the pair of rear frame attachment portions 123 to one of the pair of rear base attachment portions 114, thereby attaching the rearward end 122 of the trailer base 120 to the trailer frame 110.

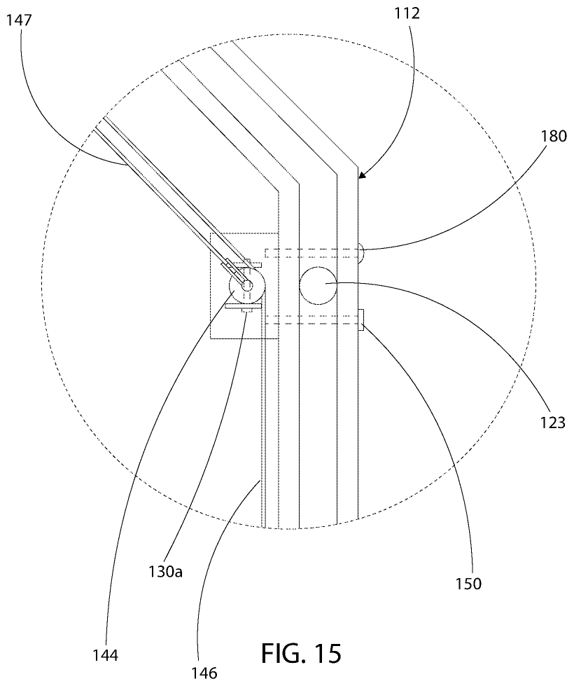

In some examples, the set of locking pins 130 may include cam pins that may be inserted into one of the apertures on the base attachment portions 113, 114 and the frame attachment portions 123, 124. For example, to lock one of the pair of front frame attachment portions 123 to one of the pair of front base attachment portions 113, as shown in FIG. 11 particularly, each of the pair of front locking pins 130a may be inserted through aperture 101c on one of the pair of front base attachment portions 113 and aperture 103c one of the pair of front frame attachment portions 123. Similarly, as shown in FIGS. 12-13, to lock one of the pair of rear frame attachment portions 124 to one of the pair of rear base attachment portions 114, each of the pair of rear locking pins 130b may be inserted through aperture 102c on one of the pair of rear base attachment portions 114 and aperture 104c one of the pair of rear base attachment portions 124. In some embodiments (as particularly demonstrated in FIG. 15) the set of locking pins 130 may be inserted at an orientation that is parallel to the pair of opposing frame rails 112.

Preferably, the trailer base 120 may be configured for selective pivotal movement from the forward end 121 thereof. To enable this, a pair of movement pins 180 may be provided (FIG. 15). The pair of movement pins 180 may be configured for attachment to the pair of front frame attachment portions 113 and the pair of front base attachment portions 123 and may enable the pivotal movement of the forward end 121 of the trailer base 120. Particularly, the pair of movement pins 180 may include threaded bolts. Each of the pair of movement pins 180 may be partially threaded into aperture 101a on one of the pair of front base attachment portions 113 (FIGS. 8A-8C and FIG. 11) and aperture 103a (FIG. 11) on one of the pair of front frame attachment portions 123, allowing the forward end 121 of the trailer base 120 to pivot about the pair of movement pins 180 (subsequent to removal of the locking pins 130 and movement restricting pins 150, which will be discussed in more detail below). As shown in FIG. 15 particularly, the pair of movement pins 180 may be inserted in an orientation that is perpendicular to the pair of opposing frame rails 112.

The trailer base moving assembly 140 may be in communication with the trailer base 120 and may enable the selective pivotal movement from the forward end 121 to facilitate the lowering of the rearward end 122 of the trailer base 120, as shown in FIG. 7. Particularly, the trailer base moving assembly 140 may be configured to, subsequent to removal of the pair of rear locking pins 130, selectively lower and raise at least the rearward end 122 of the trailer base 120. This may cause the trailer base 120 to form a ‘ramp’ such that a user is able to drive the vehicle 5 up the rearward end 122 of the trailer base 120 and onto the trailer base 120. To enable the movement of the rearward end 122 of the trailer base 120 whilst the forward end 121 of the trailer base 120 remains attached to the trailer frame 110, only the pair of rear locking pins 130 may be removed, and the pair of front locking pins 130 may be kept in.

In other embodiments, the trailer base moving assembly 140 may be configured to, subsequent to removal of both the pair of front locking pins 130 and the pair of rear locking pins 130, lower both forward end 121 and the rearward end 122 of the trailer base 120. This may enable the user to drive straight onto the trailer base 120 and may in some embodiments enable the user to move the trailer base 120 away from the trailer frame 110. This may also enable the trailer base 120 to be rotated when not attached to the tailer frame 110 and aid in rotating the vehicle 5.

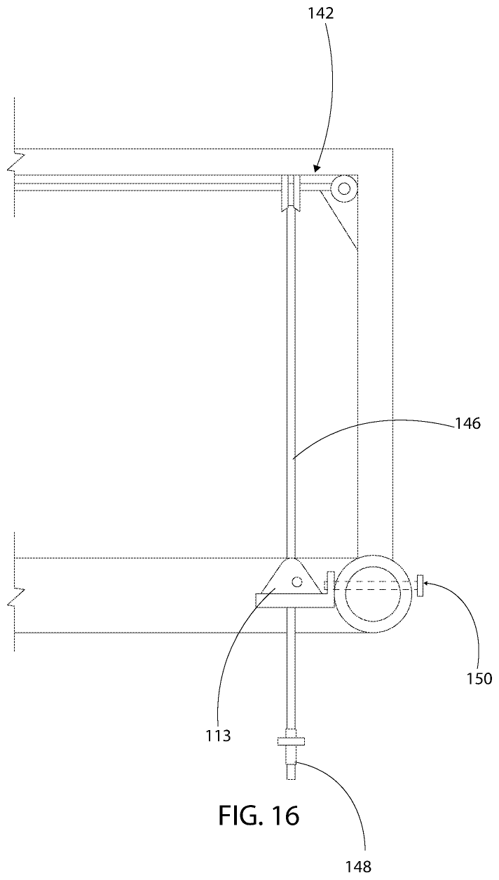

The pair of movement restricting pins 150, as particularly shown in FIGS. 15-16, may be configured for attachment into one of the pair of front frame attachment portions 123 and one of the pair of front base attachment portions 113 when locked together. Attachment of the pair of movement restricting pins 150 may arrest pivotal movement of the forward end 121 of the trailer base 120 and as such, removal of the pair of movement restricting pins 150 may permit pivotal movement of the forward end 121 of the trailer base 120 (about the pair of movement pins 180). Particularly, the pair of movement restricting pins 150 may insert into aperture 101b (FIGS. 8A-8C and FIG. 11) on one of the pair of front base attachment portions 113 and aperture 103b (FIG. 11) on one of the pair of front frame attachment portions 123. Particularly, the pair of movement restricting pins 150 may be inserted in an orientation that is perpendicular to the pair of opposing frame rails 112, as particularly shown in FIG. 15.

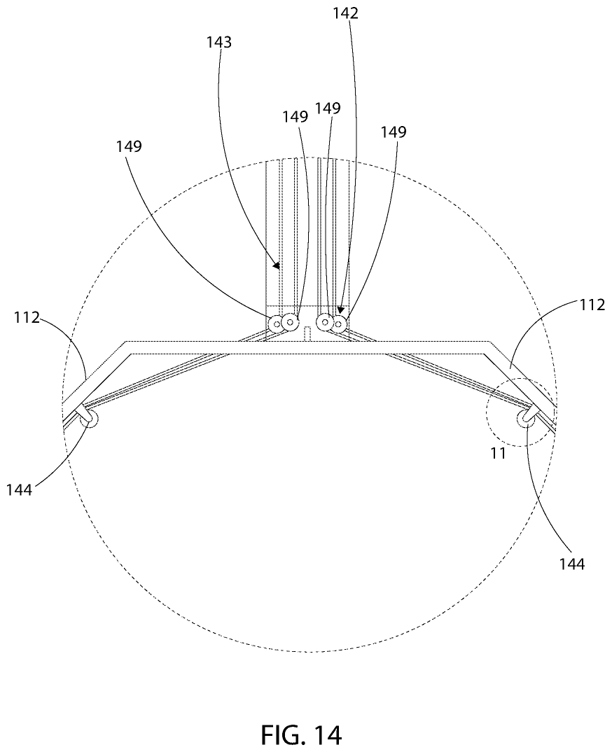

The trailer base moving assembly 140 may include a winch 141 (FIG. 7), a pulley system 142 (FIG. 14) and a cable system 143 (FIGS. 11-16). As shown in FIG. 7, the winch 141 may be attached about the front end 115 of the trailer frame 110. Particularly, the winch 141 may be attached to the front rail 111 and include a crank handle 145, allowing a user to manually actuate the trailer base moving assembly 140.

As shown in FIGS. 14, the pulley system 142 may include a pair of pulleys 144 each attached to one of the pair of opposing frame rails 112. For example, as shown in FIG. 14, the pair of pulleys 144 may be attached toward the front end 115 of the pair of opposing frame rails 112. The cable system 143 may include at least four cables, as shown in FIG. 14, spanning from the winch 141 (FIG. 7) at one end (of the cables). More particularly, as shown in FIG. 14, the pulley system 142 may further include a set of four pulleys 149 located in the front rail 111 (the wheel lock 160 is omitted in FIG. 14 for clarity). Each of the four cables may wrap around one of the four pulleys 149 and from there, section into two pairs of cables that each travel through one of the pair of opposing frame rails 112 and each wrap around one of the pair of pulleys 142, as demonstrated in FIG. 14.

As shown in FIG. 15, each of the two pairs of cables may include a rear cable 146 and a front cable 147. Both the front and rear cables 146, 147 may include a hook 148. As shown in FIGS. 11-13, the front hook 148 may attach into the front frame attachment portion 123 and the rear hook 148 may attach into the rear frame attachment portion 124, enabling the hook 148 to grip the forward end 121 and/or the rearward end 122 of the trailer base 120 to lower/raise. For example, the frame attachment portions 123, 124 may each include a hook slot 105 (FIGS. 10C-10D and FIGS. 11-12).

There may be three ways in which the trailer 100 is used. In one embodiment, assuming the trailer 100 is hitched to the towing vehicle (using the hitch assembly 172), a user may drive the vehicle 5 (with the trailer 100 attached) into a desired position. The user may then remove all four locking pins 130 and the pair of movement restricting pins 150 securing the trailer base 120 to the trailer frame 110. Then, using the winch 141, the user may lower the trailer base 120 down to a ground surface. At this point, the user may remove the trailer base 120 entirely by removing the cable system 143, which may enable the user to drive the vehicle 5 up onto the trailer base 120 without hitting the trailer frame 110. Alternatively, the user may drive the vehicle 5 onto the trailer base 120 with the cable system 143 still attached thereto. Once in position, the winch 141 may be used to raise the trailer base 120, and the four locking pins 130 and the pair of movement restricting pins 150 may be re-secured to lock the trailer base 120 to the trailer frame 110. The vehicle 5 may then be tied to the trailer frame 110. In some examples, the wheel of the vehicle 5 may be secured into the wheel lock 160.

In another embodiment, the user may drive the towing vehicle and trailer 100 into a desired position. The user may then remove the pair of rear locking pins 130, and the pair of movement restricting pins 150 at the forward end 121 of the trailer base 120. This may allow the forward end 121 of the trailer base 120 to pivot (about the pair of movement pins 180) and lower the rearward end 122 of the trailer base 120 downward, forming a ramp for the vehicle 5 to be driven up onto. The vehicle 5 must be secured using a brake or put into gear when shut off so that it doesn't move whilst on the incline of the ramp. Once the vehicle 5 is on the trailer base 120, the winch 141 may be used to raise the rearward end 122 of the trailer base 120, and the locking pins 130 and movement restricting pins 150 may be reattached. Again, the vehicle 5 and in some examples, the wheel of the vehicle 5 may be secured into the wheel lock 160.

In another embodiment, particularly for motorcycles, dimensions of the trailer base 120 may particularly allow for the motorcycle to be rotated whilst on the trailer base 120. In this embodiment, the motorcycle may be driven onto the trailer base 120 whilst on the ground surface, the trailer base 120 may then be rotated to a desired position. The trailer frame 110 may be moved back into place, the cable system 143 may be reattached, the trailer base 120 and the vehicle 5 may be winched back up, the four locking pins 130 and the movement restricting pins 150 may be reattached and again, the motorcycle may then be tied to the trailer frame 110 (and the wheel may be secured into the wheel lock 160). This may prevent the need for the user to back in or back out of the trailer 100.

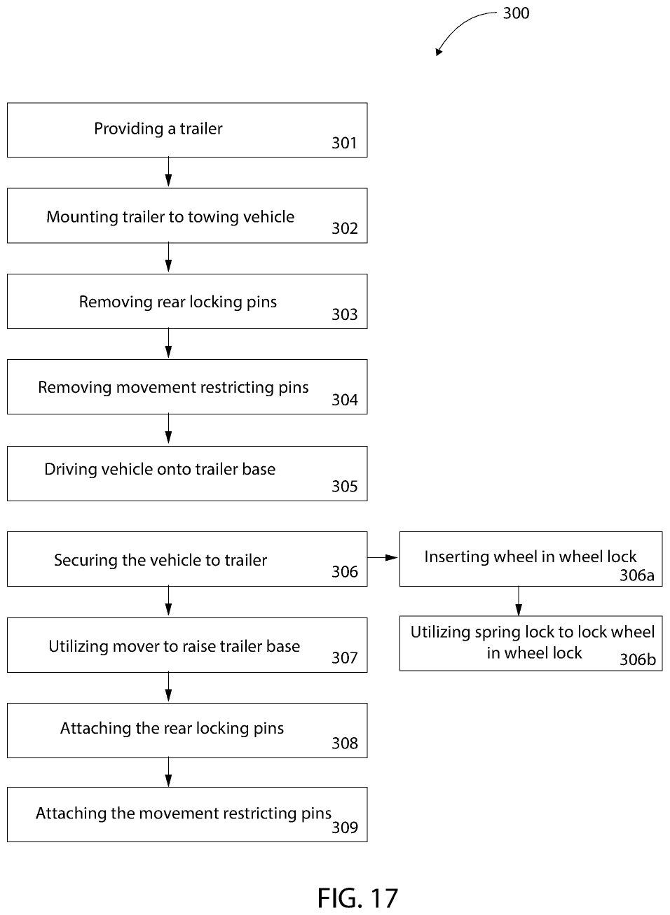

Referring now to FIG. 17 showing a flow diagram illustrating a method 300 of loading a vehicle to a trailer, according to an embodiment of the present disclosure. In particular, the method 300 may include one or more components or features of the trailer 100 as described above. As illustrated, the method 300 may include the steps of: step one 301, providing the trailer as above; step two 302, mounting the trailer to a towing vehicle using the hitch assembly; step three 303, removing the pair of rear locking pins from the pair of rear frame attachment portions and the pair of rear base attachment portions, thereby detaching the rearward end of the trailer base from the trailer frame; step four 304, removing the pair of movement restricting pins from the pair of front frame attachment portions and the pair of front base attachment portions, thereby permitting the forward end of the trailer base to pivot about the pair of movement pins and enabling the rearward end of the trailer base to move downward, forming a ramp; step five 305, driving the vehicle onto the trailer base; step six 306, securing the vehicle to the trailer base; step seven 307, utilizing the trailer base moving assembly to raise the rearward end of the trailer base; step eight 308, attaching the pair of rear locking pins to the pair of rear frame attachment portions and the pair of rear base attachment portions, thereby attaching the rearward end of the trailer base to the trailer frame; and step nine 309, attaching the pair of movement restricting pins to the pair of front frame attachment portions and the pair of front base attachment portions, thereby arresting pivotal movement of the trailer base from the forward end thereof.

As discussed above, in some examples, all locking pins may be removed and the trailer base may be completely removed from the trailer frame. Further, in some embodiments, step six 306, may include: step 306a, inserting a wheel of the vehicle into the wheel lock; and step 306b, utilizing the spring lock assembly to lock the wheel lock around the wheel of the vehicle.

It should be noted that certain steps are optional and may not be implemented in all cases. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for loading and unloading a vehicle to and from a trailer are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A trailer for loading and transporting a vehicle, the trailer comprising:
a trailer frame including a front rail and a pair of opposing frame rails extending rearwardly from the front rail and defining a left and right side of the trailer frame, the pair of frame rails together including a pair of front base attachment portions and a pair of rear base attachment portions;
a wheel assembly attached to the left and right side of the trailer frame;
a hitch assembly located on the front rail and configured to mount the trailer to a towing vehicle;
a trailer base defining a forward end opposite a rearward end, the trailer base including a pair of front frame attachment portions attached about the forward end and a pair of rear frame attachment portions attached about the rearward end, the trailer base configured for selective pivotal movement from the forward end thereof, the trailer base sized to carry the vehicle;
a set of locking pins including a pair of front locking pins and a pair of rear locking pins, the pair of front locking pins configured to lock the pair of front frame attachment portions to the pair of front base attachment portions, thereby attaching the forward end of the trailer base to the trailer frame, and the pair of rear locking pins configured to lock the pair of rear frame attachment portions to the pair of rear base attachment portions, thereby attaching the rearward end of the trailer base to the trailer frame; and
a trailer base moving assembly in communication with the trailer base, the trailer base moving assembly configured to, subsequent to removal of at least the pair of rear locking pins, selectively lower and raise at least the rearward end of the trailer base.

2. The trailer of claim 1, further comprising a pair of movement pins configured for attachment to the pair of front frame attachment portions and the pair of front base attachment portions, and wherein the pair of movement pins enable the pivotal movement of the forward end of the trailer base.

3. The trailer of claim 2, further comprising a pair of movement restricting pins configured for attachment to the pair of front frame attachment portions and the pair of front base attachment portions when locked together, wherein attachment of the pair of movement restricting pins arrests pivotal movement of the trailer base from the forward end thereof, and wherein removal of the pair of movement restricting pins permits pivotal movement of the trailer base from the forward end thereof.

4. The trailer of claim 1, further comprising a wheel lock attached about a front end of the trailer frame, the wheel lock configured to receive and stabilize a wheel of the vehicle.

5. The trailer of claim 4, wherein the wheel lock includes a pair of panels and a spring lock assembly located at the front of the pair of panels, the pair of panels hinged together and defining an opening configured to receive the wheel of the vehicle, the pair of panels being movable relative to each other to increase and decrease of the opening, the spring lock assembly configured to lock the opening around the wheel of the vehicle.

6. The trailer of claim 1, further comprising a support wheel located underneath the hitch assembly.

7. The trailer of claim 1, wherein the trailer base moving assembly includes a winch, a pulley system and a cable system, the winch being attached to the front rail, the pulley system including at least a pair of pulleys each attached to one of the pair of frame rails, the cable system including at least four cables attached to the winch at one end and sectioned into two pairs of cables that each travel through one of the pair of frame rails and each wrap around one of the pair of pulleys.

8. The trailer of claim 7, wherein the winch includes a crank handle.

9. The trailer of claim 8, wherein the each of the two pairs of cables include a rear cable and a front cable.

10. The trailer of claim 9, wherein the rear cable includes a hook.

11. The trailer of claim 1, wherein the pair of opposing frame rails each include an angled section attached to the front rail and extending at a 45 degree angle therefrom, and a linear section being substantially parallel to the front rail.

12. The trailer of claim 11, wherein the trailer frame further includes an upper frame attached to and extending above the pair of opposing frame rails, the upper frame including:
one or more vertical posts extending upwardly from the pair of opposing frame rails; and
an upper pair of opposing frame rails attached to a top end of the one or more vertical posts.

13. A trailer for loading and transporting a vehicle, the trailer comprising:
a trailer frame including a front rail and a pair of opposing frame rails extending rearwardly from the front rail and defining a left and right side of the trailer frame, the pair of frame rails together including a pair of front base attachment portions and a pair of rear base attachment portions;
a wheel assembly attached to the left and right side of the trailer frame;
a hitch assembly located on the front rail and configured to mount the trailer to a towing vehicle;
a wheel lock attached about a front end of the trailer frame and configured to receive and stabilize a wheel of the vehicle, the wheel lock including a pair of panels and a spring lock assembly, the pair of panels being hinged together and defining an opening configured to receive the wheel of the vehicle, the pair of panels being movable relative to each other to increase and decrease of the opening, the spring lock assembly located at the front of the pair of panels and configured to lock the opening around the wheel of the vehicle;
a trailer base defining a forward end opposite a rearward end, the trailer base including a pair of front frame attachment portions attached about the forward end and a pair of rear frame attachment portions attached about the rearward end, the trailer base configured for selective pivotal movement from the forward end thereof, the trailer base sized to carry the vehicle;
a set of locking pins including a pair of front locking pins and a pair of rear locking pins, the pair of front locking pins configured to lock the pair of front frame attachment portions to the pair of front base attachment portions, thereby attaching the forward end of the trailer base to the trailer frame, and the pair of rear locking pins configured to lock the pair of rear frame attachment portions to the pair of rear base attachment portions, thereby attaching the rearward end of the trailer base to the trailer frame;
a pair of movement pins configured for attachment to the pair of front frame attachment portions and the pair of front base attachment portions, the pair of movement pins enabling the pivotal movement of the forward end of the trailer base;
a pair of movement restricting pins configured for attachment to the pair of front frame attachment portions and the pair of front base attachment portions when locked together, wherein attachment of the pair of movement restricting pins arrests pivotal movement of the trailer base from the forward end thereof, and wherein removal of the pair of movement restricting pins permits pivotal movement of the trailer base from the forward end thereof;
a trailer base moving assembly in communication with the trailer base, the trailer base moving assembly configured to, subsequent to removal of at least the pair of rear locking pins, selectively lower and raise at least the rearward end of the trailer base, the trailer base moving assembly including a winch, a pulley system and a cable system, the winch attached to the front rail, the pulley system including at least a pair of pulleys each attached to one of the pair of frame rails, the cable system including at least four cables attached to the winch at one end and sectioned into two pairs of cables that each travel through one of the pair of frame rails and each wrap around one of the pair of pulleys, each of the two pairs of cables including a rear cable and a front cable, and wherein the rear cable includes a hook.

14. The trailer of claim 13, further comprising a support wheel located underneath the hitch assembly.

15. The trailer of claim 13, wherein the winch includes a crank handle.

16. The trailer of claim 13, wherein the pair of opposing frame rails each include an angled section attached to the front rail and extending at a 45 degree angle therefrom, and a linear section being substantially parallel to the front rail.

17. The trailer of claim 16, wherein the trailer frame further includes an upper frame attached to and extending above the pair of opposing frame rails, the upper frame including:
one or more vertical posts extending upwardly from the pair of opposing frame rails; and
an upper pair of opposing frame rails attached to a top end of the one or more vertical posts.

18. A method of loading a vehicle onto a trailer, the method comprising:
providing the trailer, the trailer including:
a trailer frame including a front rail and a pair of opposing frame rails extending rearwardly from the front rail and defining a left and right side of the trailer frame, the pair of frame rails together including a pair of front base attachment portions and a pair of rear base attachment portions;
a wheel assembly attached to the left and right side of the trailer frame;
a hitch assembly located on the front rail;
a trailer base defining a forward end opposite a rearward end, the trailer base including a pair of front frame attachment portions attached about the forward end and a pair of rear frame attachment portions attached about the rearward end, the trailer base configured for selective pivotal movement from the forward end thereof;
a set of locking pins including a pair of front locking pins and a pair of rear locking pins, the pair of front locking pins configured to lock the pair of front frame attachment portions to the pair of front base attachment portions, thereby attaching the forward end of the trailer base to the trailer frame, and the pair of rear locking pins configured to lock the pair of rear frame attachment portions to the pair of rear base attachment portions, thereby attaching the rearward end of the trailer base to the trailer frame;
a pair of movement pins configured for attachment to the pair of front frame attachment portions and the pair of front base attachment portions, the pair of movement pins enabling the pivotal movement of the forward end of the trailer base;
a pair of movement restricting pins configured for attachment to the pair of front frame attachment portions and the pair of front base attachment portions when locked together; and
a trailer base moving assembly in communication with the trailer base;
mounting the trailer to a towing vehicle using the hitch assembly;
removing the pair of rear locking pins from the pair of rear frame attachment portions and the pair of rear base attachment portions, thereby detaching the rearward end of the trailer base from the trailer frame;
removing the pair of movement restricting pins from the pair of front frame attachment portions and the pair of front base attachment portions, thereby permitting the forward end of the trailer base to pivot about the pair of movement pins, and enabling the rearward end of the trailer base to move downward, forming a ramp;
driving the vehicle onto the trailer base;
securing the vehicle to the trailer base;
utilizing the trailer base moving assembly to raise the rearward end of the trailer base;
attaching the pair of rear locking pins to the pair of rear frame attachment portions and the pair of rear base attachment portions, thereby attaching the rearward end of the trailer base to the trailer frame; and
attaching the pair of movement restricting pins to the pair of front frame attachment portions and the pair of front base attachment portions, thereby arresting pivotal movement of the trailer base from the forward end thereof.

19. The method of claim 18, wherein the trailer further comprises a wheel lock attached about a front end of the trailer frame and configured to receive and stabilize a wheel of the vehicle, the wheel lock including a pair of panels attached together at a front thereof and defining an opening, the pair of panels being movable relative to each other to increase and decrease of the opening, the wheel lock further including a spring lock assembly located at the front of the pair of panels, the spring lock assembly configured to lock the opening around the wheel of the vehicle, and

20. The method of claim 19, wherein the step of securing the vehicle includes:
inserting a wheel of the vehicle into the wheel lock; and
utilizing the spring lock assembly to lock the wheel lock around the wheel of the vehicle.
